(19) United States
(12) Patent Application Publication
(10) Pub. No.: US 2012/0185261 A1
(43) Pub. Date: Jul. 19, 2012

(54) Rapid Early Sizing

(76) Inventor: Capers Jones, Narragansett, RI (US)

(21) Appl. No.: 13/352,434

(22) Filed: Jan. 18, 2012

Related U.S. Application Data
(60) Provisional application No. 61/434,091, filed on Jan. 19, 2011.

(51) Int. Cl. G06Q 10/06

(52) U.S. Cl. 705/1.1

(57) ABSTRACT

The invention uses a combination of historical data, pattern matching, and mathematical modeling to predict software application size prior to the availability of complete requirements or specifications. The invention's approach to sizing allows software application size to be predicted earlier and faster than many other methods such as normal function point analysis by certified counters.

### PRIORITY

This application claims priority to provisional application 61/434,091 filed on Jan. 19, 2011.

### BACKGROUND

Estimating the size, reliability, and cost of a software project is often desired for feasibility analysis, budgeting, business planning, and many other reasons. There are a number of approaches to performing this estimation, but they often require a full requirements analysis, and often produce results little better than an educated guess.

One approach to measure size of a software application is through the use of function points. But function point analysis may not be used until requirements are complete, which often means between one month and twelve months after a preliminary cost estimate may be needed.

### SUMMARY

The instant application discloses ways to predict the size of a software application. A user enters data about the planned development project, and algorithms may provide estimates for costs, function point counts, lines of code, feature creep, and timelines. Other metrics may also be estimated, such as resources need for documentation, data base volumes, software specifications, or other project outputs.

In one embodiment, the algorithms may use pattern matching to compare various inputs to known project metrics to estimate new project metrics.

### BRIEF DESCRIPTION OF THE DRAWINGS

FIG. 1 is an example of one embodiment of a system which may support Rapid Early Sizing.

FIG. 2 is a flowchart showing steps in one embodiment of Rapid Early Sizing.

FIG. 3 illustrates a sample input for some of the parameters of one embodiment of Rapid Early Sizing.

FIG. 4 illustrates another sample input for some of the parameters of one embodiment of Rapid Early Sizing.

FIG. 5 illustrates a component diagram of a computing device according to one embodiment.

### DETAILED DESCRIPTION

The instant application discloses techniques of estimating costs, function point counts, lines of code, feature creep, timelines, resources needed for documentation, data base volumes, software specifications, or other project outputs.

A taxonomy may be used to identify characteristics of an application to be developed. This taxonomy may include classifications for various aspects of the application, such as data complexity, target users, development methodology, algorithmic complexity, and other classifications. An example of a taxonomy is illustrated in Appendix 1.

The taxonomy in Appendix 1 has seven factors that may be used to classify projects: Nature, Scope, Class, Type, Problem Complexity, Code Complexity, and Data complexity. Further information which may influence size and timeline of a project may include CMMI Level, Methodology, and Project Goals.

Using a taxonomy which has been applied to classify existing measured applications, a size of a new application may be estimated by comparing characteristics of the new application with characteristics of the existing measured applications.

Additionally, taxonomy classifications may have associated sizes or weightings. Table 2 in Appendix 1 illustrates one example of function point counts based on a Project Scope. As may be seen in Table 2, as a rough estimate, an algorithm project may have one function point, while a standalone program may have 500.

Examples of weightings are shown in Tables 3 through Table 8 in Appendix 1. These weightings may be used to adjust the rough estimate obtained by the Project Scope. For example, looking at Table 3, a Project Class input of 40 may indicate that the rough estimate may stay the same (adjustment factor of 1.00) for that classification, which corresponds with an internal program at one location. In contrast, a Project Class input of 180, signifying an external program in a cloud, would cause the rough estimate to be increased by 9% (adjustment factor of 1.09).

Similarly, Tables 4 through 8 show examples of weightings that may be used based on the example taxonomy of Appendix 1.

Table 9 provides an example of values that may be used to provide estimates of a schedule for a project. For example, if the project team is at CMMI Level 1 and the project has 1000 function points, a rough estimate for the schedule would be 15.85 months. This number may be obtained by calculating the estimated number of function points to the power of the CMMI level (0.4 for CMMI Level 1), giving 15.85. For another example, if the project team is at CMMI Level 3 and the project has 10,000 function points, a rough estimate for the schedule would be 33.11 months.

Table 10 provides examples of schedule adjustments for various development methodologies. Using the previous example of a 1000 function point project with a project team at CMMI Level 1, using an Agile development methodology would reduce the estimated schedule; the 15.85 months would be multiplied by 0.94 to give a revised estimate of 14.90 months.

Table 11 provides examples of adjustments based on the goals of a project, which generally involves adding staff if a project manager has a goal of shortening the delivery time. Again using the previous example of a 1000 function point project, CMMI level 1, and Agile development for a 14.90 month schedule, a project manager may target a 0.95 or 0.91 factor to complete the project earlier.

After initial size estimates have been obtained, requirements creep may be estimated. Requirements creep primarily occurs during design and coding phases, which may be 50% of the total schedule. Requirements creep may correlated with Problem Complexity for a project, using the values of Table 5 read as percentages per month. For example, again using our 14.90 month schedule, if the Problem Complexity rating was 30, the adjustment factor is 0.80. Reading that as a percentage, we obtain a value of 0.8%. Simple interest-type calculations may be used, so we take 50% of the total schedule, which is roughly 7.5 months, and multiply that by 0.8% times the original 1000 function points, giving 60 extra function points for a total of 1060 function points at delivery. This requirements creep may also affect delivery schedule estimates.

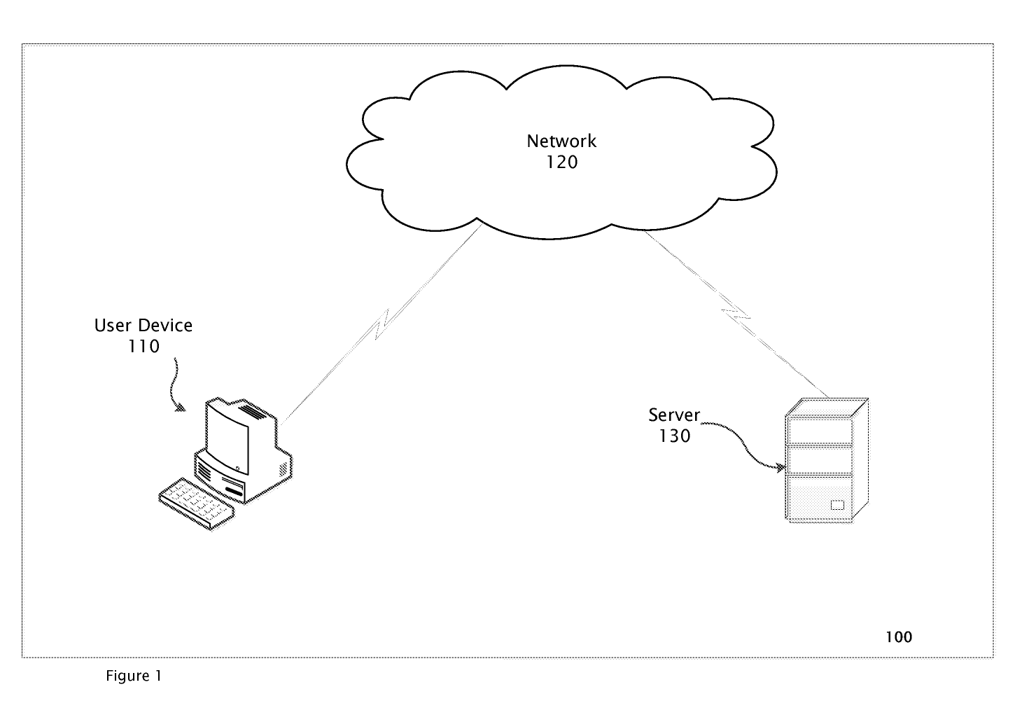

FIG. 1 is an example of one embodiment of a System 100 which may support Rapid Early Sizing. In this example, Server 130 may hold taxonomy-classified characteristics of previously measured projects, and rules concerning how various factors may affect baseline sizes of projects. In this embodiment, Server 130 may comprise one or more physical computers. A user may enter characteristics using the same or a similar taxonomy of a new application to be sized by using User Device 110 to interact with Server 130 over a Network 120. In this embodiment User Device 110 may be a personal computer, a cell phone, a laptop, or a netbook. Other types of devices may be used in other embodiments.

Network 120 may be a local area network, a wide area network, an internet, or other type of communicate channel for User Device 110 to interchange information with Server 130.

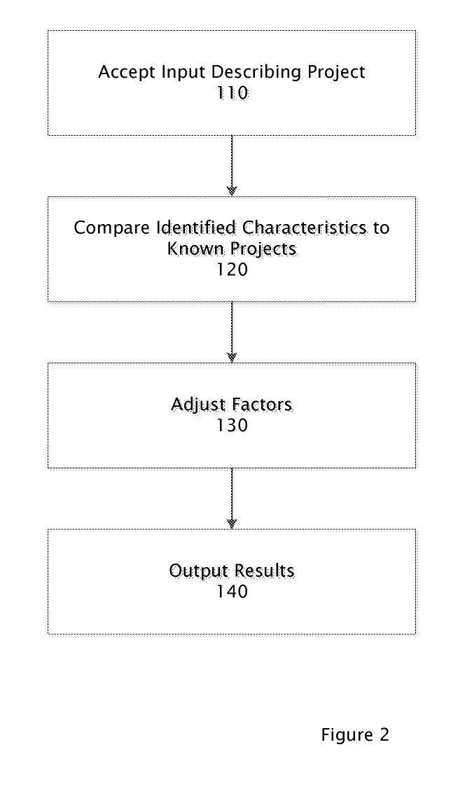

FIG. 2 is a flowchart showing steps in one embodiment of Rapid Early Sizing. A Rapid Early Sizing process may Accept Input Describing a Project 110, which may include characteristics associated with a taxonomy.

Pattern matching algorithms may be used to find similar known projects by Comparing Identified Characteristics to previously-sized projects (“Known Projects”) 120. Using a taxonomy for the Identified Characteristics that was used to classify previously measured projects may allow a rough initial estimated size to be obtained. Factors may be Adjusted 130 based on further considerations of the taxonomy, and interpolations may be performed to provide estimates for new projects that fall between known projects. Mathematical adjustments based on the nature, scope, class, type, problem complexity, code complexity, and data complexity factors may be made. This Factor Adjustment may cause the initial estimated size of an application to be adjusted upwards or downwards.

In one embodiment, function point estimates may be obtained corresponding to version 4.2 of the International Function Point Users Group (IFPUG) counting rules, or other function point counting methods. Examples of other function point metrics include COSMIC function points, Mark II function points, NESMA function points, Finnish function points, Feature points, unadjusted function points, Australian function points. Future variations of function point evaluations that do not exist today may also be supported.

The algorithms used for sizing may be metric neutral, and may also be used to produce size estimates using non-functional metrics such as logical code statements, physical lines of code, story points, use-case points, web-object points, or Reports, Interfaces, Conversions, Enhancements (RICE) objects. The sizing algorithms may be modified to generate size in other metrics that deal with software sizing if the metrics are regular and if they may be mathematically related to IFPUG function points.

Additionally, a set of algorithms that predict the growth of creeping requirements during development may be implemented. Software requirements in some cases may grow and change at rates between 0.5% per calendar month and 2.0% per calendar month during design and coding phases.

Results may then be Output 140 on a screen, printer, or another type of output device.

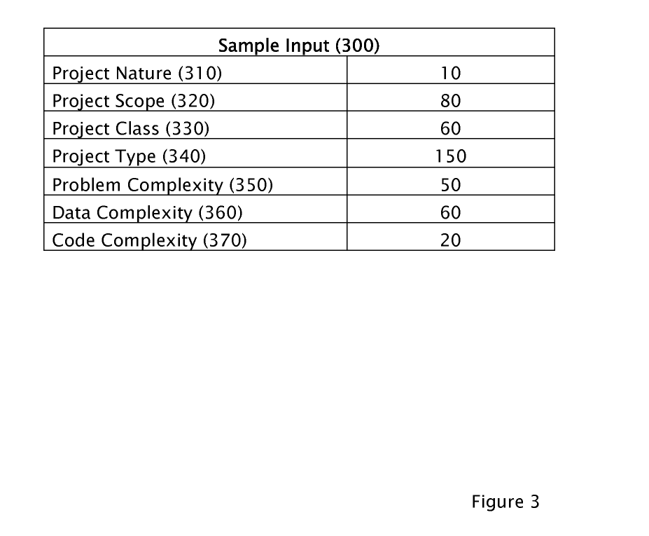

FIG. 3 illustrates a Sample Input 300 for some of the parameters of Rapid Early Sizing. For this example, the taxonomy shown in Appendix 1 may be used with pattern matching to match the size characteristics of software applications against known sizes of historical projects that have already been counted. The algorithms may use a taxonomy that may provide an unambiguous placement of a software project in terms of its nature, scope, class, type, problem complexity, code complexity, and data complexity. The taxonomy may be used for both measurement and estimation purposes. It may also be used for benchmark comparisons to ensure that similar projects are being compared.

In this example, Project Nature (310) has a value of 10, which, from Table 1 in Appendix 1, indicates that it is new software application development. Table 2 shows us that Project Scope (320) having a value of 80 indicates that it is a standalone program.

In this example, Project Class (330) has a value of 60. In one embodiment of Rapid Early Sizing, Project Class may use the values shown in Table 3 in Appendix 1. In this example, the Project Class (330) indicates it is an internal program for an intranet.

Project Type (340) has a value of 150. For this example, Table 5 in Appendix 1 indicates it is a process-control program.

Project Nature (310), Project Scope (320), Project Class (330), and Project Type (340) provide information about the type of project that is being sized. Further information indicating how complex various aspects of the project are may be used to adjust estimates up or down.

The value of 50 for Problem Complexity (350) in FIG. 3 indicates that the algorithms and calculations are of average complexity.

For the example shown in FIG. 3, the Data Complexity (360) having a value of 60 may indicate that the application being sized has multiple files with some complex data elements and interactions based Table 7 in Appendix 1.

In FIG. 3, Code Complexity (370) has a value of 20. In one embodiment of Rapid Early Sizing, Code Complexity (270) may use values as shown in Table 8 in Appendix 1. A value of 20 for Code Complexity (370) in this example may indicate that it is simple nonprocedural code (such as generated, database, or spreadsheet, for example).

The Sample Input 300 may provide estimates for a project as follows:
a. Project Scope (30) 80, Standalone Program, gives an initial size of 500 function points.
b. Project Class (330) 60, Internal Program, Intranet, adjusts the estimate by a factor of 1.04, giving 524 function points.
c. Project Type (340) 150, Process Control, adjusts by 1.08, giving 566 function points.
d. Problem Complexity (350) 50, Algorithms and calculations of average complexity, adjusts by 1.00, still giving 566 function points.
e. Data Complexity (360) 60, Multiple file with some complex data elements and interactions, adjusts by 1.05, giving 594 function points.
f. Code Complexity (370) 20, Simple nonprocedural code, adjusts by 0.92, giving 546 function points.

One having skill in the art will recognize that adjustments may be made in any order, and that some may be ignored and others adding without differing from the scope of Rapid Early Sizing.

Once having an estimate of 546 function points as a size of an application, an estimated schedule may be provided. If CMMI Level 1 is applicable, the estimated schedule in months is obtained by taking 546 to the power of 0.4 (from Table 9 in Appendix 1), giving 12.4 months. If a team in this example is using an Agile development methodology, the schedule may be adjusted by 0.94 (from Table 10 in Appendix 1), giving 11.7 months. If a project manager is aiming at a shorter schedule and adds staff, from Table 11 in Appendix 1, the schedule may be adjusted by a factor of 0.95, giving 11.1 months.

Requirements creep may increase a project's size, and may be related to Problem Complexity. In this example, Problem Complexity had an adjustment value of 1.00. Treating this as a percentage applied during design and coding phases, or about 50%, of the project, we get 1.00% per month for half of 11.1 months, or approximately 5.6%. Adjusting the previous function point count, 546*1.06, we now get 579 function points. This may also extend the schedule to 11.8 months

Thus the example inputs of FIG. 3 may result in estimates of 579 function points in size, and a schedule of 11.8 months. These estimates were rounded to one place after the decimal for most calculations, other embodiments may provide more accurate estimates.

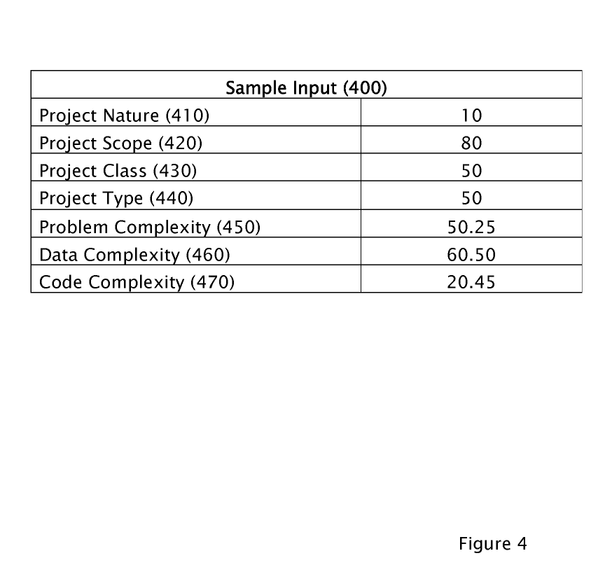

FIG. 4 illustrates another sample input for some of the parameters of one embodiment of Rapid Early Sizing. This example may use the example values for the taxonomies listed in Appendix 1, which may indicate Project Nature's (410) value of 10 indicates it is a new software application development. Project Scope's (420) 80 indicates it is a Standalone program; for Project Class (430), 50 indicates it is an Internal program, for use at a multiple locations. Project Type (440) has a value of 50, indicating the application being sized is an interactive GUI applications program. In this embodiment, Problem Complexity (350), Data Complexity (360), and Code Complexity (370) may have non-integral values assigned (50.25, 60.50, and 20.45 respectively). These numbers each indicate that the application being sized falls between two values of their respective taxonomies. Rapid Early Sizing may interpolate when such input is provided, which may improve the estimates provided by Rapid Early Sizing.

The input values may be matched in a table of initial size values that provides approximate average starting sizes for each unit in a scope portion of the taxonomy, as derived from previously-sized applications and subcomponents.

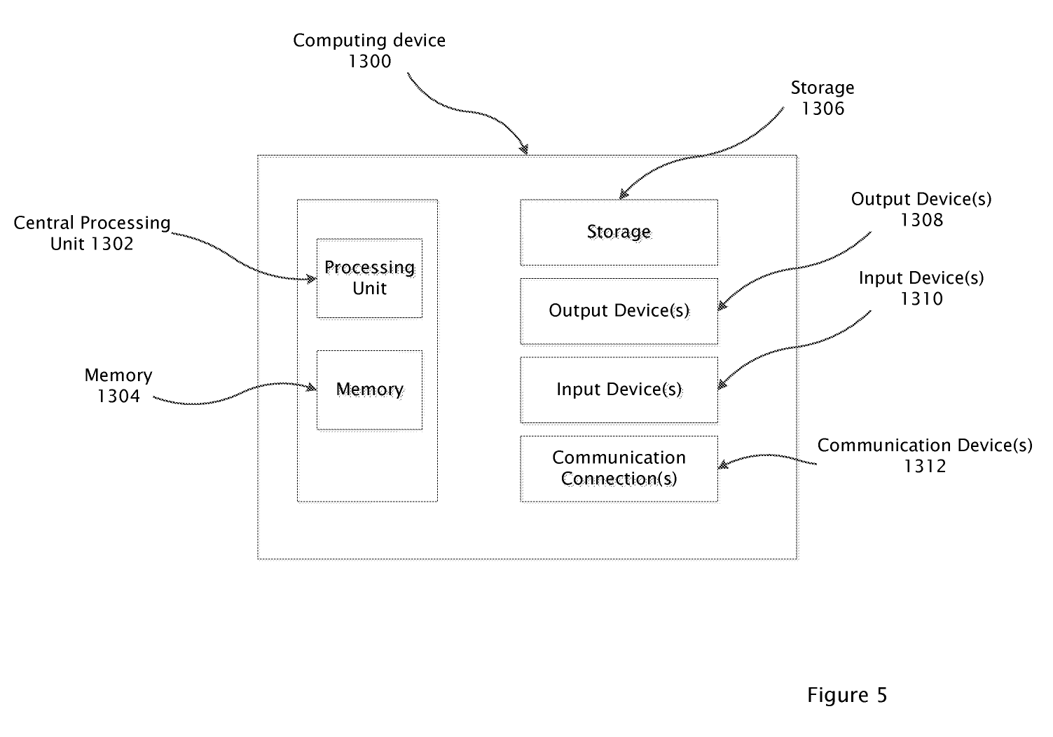

FIG. 5 illustrates a component diagram of a computing device according to one embodiment. The computing device (1300) can be utilized to implement one or more computing devices, computer processes, or software modules described herein. In one example, the computing device (1300) can be utilized to process calculations, execute instructions, receive and transmit digital signals. In another example, the computing device (1300) can be utilized to process calculations, execute instructions, receive and transmit digital signals, receive and transmit search queries, and hypertext, compile computer code as required by a Server (140) or a Client (150). The computing device (1300) can be any general or special purpose computer now known or to become known capable of performing the steps and/or performing the functions described herein, either in software, hardware, firmware, or a combination thereof.

In its most basic configuration, computing device (1300) typically includes at least one central processing unit (CPU) (1302) and memory (1304). Depending on the exact configuration and type of computing device, memory (1304) may be volatile (such as RAM), non-volatile (such as ROM, flash memory, etc.) or some combination of the two. Additionally, computing device (1300) may also have additional features/functionality. For example, computing device (1300) may include multiple CPU's. The described methods may be executed in any manner by any processing unit in computing device (1300). For example, the described process may be executed by both multiple CPU's in parallel.

Computing device (1300) may also include additional storage (removable and/or non-removable) including, but not limited to, magnetic or optical disks or tape. Such additional storage is illustrated in FIG. 8 by storage (1306). Computer storage media includes volatile and nonvolatile, removable and non-removable media implemented in any method or technology for storage of information such as computer readable instructions, data structures, program modules or other data. Memory (1304) and storage (1306) are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing device (1300). Any such computer storage media may be part of computing device (1300).

Computing device (1300) may also contain communications device(s) (1312) that allow the device to communicate with other devices. Communications device(s) (1312) is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer-readable media as used herein includes both computer storage media and communication media. The described methods may be encoded in any computer-readable media in any form, such as data, computer-executable instructions, and the like.

Computing device (1300) may also have input device(s) (1310) such as keyboard, mouse, pen, voice input device, touch input device, etc. Output device(s) (1308) such as a display, speakers, printer, etc. may also be included. All these devices are well known in the art and need not be discussed at length.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

While the detailed description above has been expressed in terms of specific examples, those skilled in the art will appreciate that many other configurations could be used. Accordingly, it will be appreciated that various equivalent modifications of the above-described embodiments may be made without departing from the spirit and scope of the invention.

Additionally, the illustrated operations in the description show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

The foregoing description of various embodiments of the invention has been presented for the purposes of illustration and description. It is not intended to be exhaustive or to limit the invention to the precise form disclosed. It is intended that the scope of the invention be limited not by this detailed description, but rather by the claims appended hereto. The above specification, examples and data provide a complete description of the manufacture and use of the invention.

### Appendix 1

TABLE 1
PROJECT NATURE

| | |
|---|---|
| 10 | New software application development |
| 20 | Minor enhancement (change to current application based on new |
| | requirement) |
| 30 | Major enhancement (significant new functions added to existing |
| | software) |
| 40 | Minor package customization |
| 50 | Major package customization |
| 60 | Maintenance (defect repair to existing software) |
| 70 | Conversion or adaptation (migration to new hardware platform) |
| 80 | Conversion or adaptation (migration to a new operating system) |
| 90 | Reengineering (re-implementing a legacy application) |
| 100 | Package installation with no customization |
| 110 | Package installation, data migration, and customization |

### Appendix 1

TABLE 2
APPLICATION SCOPE

| Value | Definition | Size in Function Points |
|---|---|---|
| 10 | Algorithm | 1 |
| 20 | Subroutine | 5 |
| 30 | Module | 10 |
| 40 | Reusable module | 20 |
| 50 | Disposable prototype | 50 |
| 60 | Evolutionary prototype | 75 |
| 70 | Subprogram | 250 |
| 80 | Standalone program | 500 |
| 85 | Multi-component | 750 |
| 90 | Component of a system | 1,250 |
| 100 | Release of a system | 2,500 |
| 110 | New Departmental system | 7,500 |
| 120 | New Corporate system | 15,000 |
| 130 | New Enterprise system | 35,000 |
| 140 | New National system | 50,000 |
| 150 | New Global system | 150,000 |

### Appendix 1

### The Adjustment Factors for the Initial Size Value

Each of the other factors is capable of adjusting the initial size by a percentage that will either raise or lower the initial value. The adjustment factors are:

TABLE 3
PROJECT CLASS

| Value | Definition | Adjustment |
|---|---|---|
| 10 | Personal program | 0.80 |
| 20 | Personal, to be used by others | 0.85 |
| 30 | Academic program | 0.95 |
| 40 | Internal program, 1 location | 1.00 |
| 50 | Internal program, n locations | 1.03 |
| 60 | Internal program, intranet | 1.04 |
| 70 | Internal program, contracted | 1.05 |
| 80 | Internal program, time share | 1.07 |
| 90 | Internal program, military | 1.10 |
| 100 | External program, public | 1.02 |
| 110 | External program, internet | 1.04 |
| 120 | External program, open source | 1.05 |
| 130 | External program, leased | 1.05 |
| 140 | External program, bundled | 1.06 |
| 150 | External program, unbundled | 1.07 |
| 160 | External program, contract | 1.08 |
| 170 | External program, SaaS | 1.08 |
| 180 | External program, cloud | 1.09 |
| 190 | External program, government | 1.10 |
| 200 | External program, military | 1.12 |

### Appendix 1

TABLE 4
PROJECT TYPE ADJUSTMENTS

| Value | Definition | Adjustment |
|---|---|---|
| 10 | Nonprocedural | 0.80 |
| 20 | Batch application | 0.90 |
| 30 | World wide web | 0.95 |
| 40 | Interactive application | 1.01 |
| 50 | Interactive GUI application | 1.02 |
| 60 | Batch data base | 1.03 |
| 70 | Interactive data base | 1.04 |
| 80 | Client/server | 1.05 |
| 90 | Computer games | 1.06 |
| 100 | Scientific or mathematical | 1.06 |
| 110 | Expert system | 1.07 |
| 120 | Systems or middleware | 1.07 |
| 130 | Service-oriented architecture | 1.07 |
| 140 | Communication software | 1.07 |
| 150 | Process control | 1.08 |
| 160 | Trusted system | 1.08 |
| 170 | Embedded or real time | 1.08 |
| 180 | Graphics or animation | 1.08 |
| 190 | Multimedia application | 1.09 |
| 200 | Robotics application | 1.10 |
| 210 | Artificial intelligence | 1.11 |
| 220 | Neural net | 1.12 |
| 230 | Hybrid (multiple types) | |
| 232 | Primary type | |
| 234 | Secondary type | |
| 236 | Average value | |

### Appendix 1

TABLE 5
PROBLEM COMPLEXITY PARAMETER

| Value | Definition | Adjustment |
|---|---|---|
| 10 | Simple calculations; simple algorithms | 0.60 |
| 20 | Majority of simple calculations and | 0.70 |
| | algorithms | |
| 30 | Majority of simple, but some average | 0.80 |
| | calculations | |
| 40 | Mix of simple and average calculations | 0.90 |
| 50 | Algorithms and calculations of average | 1.00 |
| | complexity | |
| 60 | Difficult, average, and simple calculations | 1.05 |
| 70 | More difficult algorithms than average | 1.07 |
| 80 | Large majority of difficult algorithms | 1.10 |
| 90 | Some algorithms are very complex | 1.12 |
| 100 | All algorithms very complex | 1.15 |

### Appendix 1

TABLE 6
DATA COMPLEXITY

| Value | Definition | Adjustment |
|---|---|---|
| 10 | No permanent data or files required by | 0.50 |
| | application | |
| 20 | Only one simple file required, with few data | 0.55 |
| | interactions | |
| 30 | One or two files, simple data, and little | 0.75 |
| | complexity | |
| 40 | Several data elements, but simple data | 0.90 |
| | relationships | |
| 50 | Multiple files and data interactions of | 1.00 |
| | normal complexity (default) | |
| 60 | Multiple files with some complex data | 1.05 |
| | elements and interactions | |
| 70 | Multiple files, complex data elements and | 1.07 |
| | data interactions | |
| 80 | Multiple files, majority of complex data | 1.10 |
| | elements and interactions | |
| 90 | Multiple files, complex data elements, many | 1.15 |
| | data interactions | |
| 100 | Numerous complex files, data elements, and | 1.20 |
| | complex interactions | |

### Appendix 1

TABLE 7
CODE COMPLEXITY PARAMETER

| Value | Definition | Adjustment |
|---|---|---|
| 10 | Most programming done with controls | 0.90 |
| 20 | Simple nonprocedural code | 0.92 |
| 30 | Simple plus average nonprocedural code | 0.95 |
| 40 | Program skeletons and reused code | 0.97 |
| 50 | Average structure with simple paths | 1.00 |
| 60 | Well-structured, but some complex paths | 1.03 |
| 70 | Some complex paths, modules, links | 1.05 |
| 80 | Above average complexity of paths, | 1.07 |
| | modules | |
| 90 | Majority of paths, modules large and | 1.09 |
| | complex | |
| 100 | Extremely complex paths and modules | 1.11 |

### Appendix 1

TABLE 8
DATA COMPLEXITY PARAMETER

| Value | Definition | Adjustment |
|---|---|---|
| 10 | No permanent files or data | 0.50 |
| 20 | Only one simple file | 0.55 |
| 30 | One or two simple files | 0.75 |
| 40 | Several files but simple relationships | 0.90 |
| 50 | Multiple files and data interactions | 1.00 |
| 60 | Multiple files with some complex data | 1.05 |
| 70 | Multiple files, complex data and | 1.07 |
| | interactions | |
| 80 | Multiple files, majority of complex data | 1.10 |
| 90 | Multiple files, many complex interactions | 1.15 |
| 100 | Numerous complex files, data, and | 1.20 |
| | interactions | |

TABLE 9
Schedules Related to CMMI Levels

| | CMMI 1 | CMMI 2 | CMMI 3 | CMMI 4 | CMMI 5 |
|---|---|---|---|---|---|
| Power | 0.4 | 0.39 | 0.38 | 0.37 | 0.36 |
| Function | | | | | |
| Points | Months Required | | | | |
| 1 | 1.00 | 1.00 | 1.00 | 1.00 | 1.00 |
| 10 | 2.51 | 2.45 | 2.40 | 2.34 | 2.29 |
| 100 | 6.31 | 6.03 | 5.75 | 5.50 | 5.25 |
| 1,000 | 15.85 | 14.79 | 13.80 | 12.88 | 12.02 |
| 10,000 | 39.81 | 36.31 | 33.11 | 30.20 | 27.54 |
| 100,000 | 100.00 | 89.13 | 79.43 | 70.79 | 63.10 |

### Appendix 1

TABLE 10
Schedule Adjustments for Methodologies

| Methodology | Adjustment |
|---|---|
| None | 1.10 |
| Waterfall | 1.00 |
| Internal | 0.97 |
| Agile | 0.94 |
| RUP | 0.92 |
| PSP/TSP | 0.90 |
| Hybrid | 0.88 |

TABLE 11
Schedule Adjustments for Project Goals

| Goals | Adjustment |
|---|---|
| Normal | 1.00 |
| Shorter | 0.95 |
| Shortest | 0.91 |

1. A method of estimating a project's size, comprising:
receiving at least a first characteristic of the project; the characteristic associated with a taxonomy for classifying projects;
finding at least one similar previously-sized project based on at least the first characteristic received; and
calculating a first estimate based on the size of the similar previously-sized project.

2. The method of claim 1 wherein the taxonomy comprises a way to classify a nature of the project.

3. The method of claim 1 wherein the taxonomy comprises a way to classify a scope of the project.

4. The method of claim 1 wherein the taxonomy comprises a way to classify a class of the project.

5. The method of claim 1 wherein the taxonomy comprises a way to classify a type of the project.

6. The method of claim 1 further comprising:
receiving at least a second characteristic, the second characteristic associated with a second taxonomy for classifying projects;
applying a weight associated with the characteristic in the taxonomy;
calculating a second estimate based on the first estimate and the weight.

7. A system comprising:
a processor;
a memory coupled to the processor;
a taxonomy component configured to allow classification of a project;
a characteristics receiving component configured to receive characteristics of a project;
a classifying component configured to use received characteristics to classify the project in the taxonomy;
a known-size projects component configured to store characteristics and sizes of known-size projects;
a matching component configured to match the characteristics of the project with characteristics of known-size projects;
an estimating component configured to provide a first estimate of a size of the project based on sizes of matched known-size projects; and
an output component configured to output the an estimate of the size of the project.

8. The system of claim 7 wherein the taxonomy comprises at least one classification from a group comprising nature of a project, scope of a project, class of a project, and type of a project.

9. The system of claim 7 further comprising:
a weighting characteristics receiving component configured to receive weighting characteristics of the project; and
a weighting characteristics evaluation component configured to provide a second estimate of a size of the project based on the first estimate and received weighting characteristics of the project.

10. The System of claim 9 wherein the weighting characteristics comprise at least one characteristic from a group comprising: problem complexity, data complexity, and code complexity.

11. Computer readable storage media containing instructions that, when executed, cause a processor to perform a method comprising:
receiving at least a first characteristic of a project; the characteristic associated with a taxonomy for classifying projects;
finding at least one similar previously-sized project based on at least the first characteristic received; and
calculating a first estimate based on the size of the similar previously-sized project.

12. The method of claim 11 wherein the taxonomy comprises a way to classify a nature of the project.

13. The method of claim 11 wherein the taxonomy comprises a way to classify a scope of the project.

14. The method of claim 11 wherein the taxonomy comprises a way to classify a class of the project.

15. The method of claim 11 wherein the taxonomy comprises a way to classify a type of the project.

16. The method of claim 11 further comprising:
receiving at least a second characteristic, the second characteristic associated with a second taxonomy for classifying projects;
applying a weight associated with the characteristic in the taxonomy;
calculating a second estimate based on the first estimate and the weight.

17. The method of claim 16 wherein the second estimate comprises an estimate of function points based upon IFPUG 4.2 standards.

18. The Method of claim 16 wherein the project is a software development project.

19. The method of claim 18 wherein the second estimate comprises an estimate of feature creep for the software development project.

20. The method of claim 18 wherein the second estimate comprises an estimate of the development time the project will require.
